(19) United States
(12) Patent Application Publication
(10) Pub. No.: US 2009/0126495 A1
(43) Pub. Date: May 21, 2009

(54) Ultrasonic Spectroscopic Method for Chemical Mechanical Planarization

(75) Inventors: Mahesh C. Bhardwaj, State College, PA (US); Micahel S. Biviano, State College, PA (US); Raghu S. Srivatsa, State College, PA (US); Thomas J. Eischeid, State College, PA (US)

Correspondence Address: THE WEBB LAW FIRM, P.C., 700 KOPPERS BUILDING, 436 SEVENTH AVENUE, PITTSBURGH, PA, 15219, US

(73) Assignee: THE ULTRAN GROUP, INC., State College, PA (US)

(21) Appl. No.: 12/272,109

(22) Filed: Nov. 17, 2008

Related U.S. Application Data
(60) Provisional application No. 60/988,237, filed on Nov. 15, 2007.

(51) Int. Cl. G01N 29/12

(52) U.S. Cl. 73/627

(57) ABSTRACT

A method of characterizing the surface of a CMP pad by directing an ultrasound pulse at the surface from an ultrasound transducer that is not in contact with the surface and observing the frequency spectrum of the reflected pulse which is indicative of properties of the surface.

### BACKGROUND OF THE INVENTION

1. Field of the Invention

This invention relates to the characterization of the properties of a surface, for example, the surface of chemical mechanical polishing pads.

2. Description of Related Art

In order to produce high quality surfaces of silicon wafers, the semiconductor manufacturers utilize a polishing process known as the Chemical Mechanical Planarization (CMP) polishing method, which employs, among others, a variety of polyurethane pads varying in density and microstructure in conjunction with abrasive slurries and specially formulated chemicals. Since during this process the materials to be polished come in direct contact with the polishing pads, the surface quality of the polishing pads and other characteristics and features thereof play an extremely significant role in determining the quality of semiconductor materials. Initially, a new CMP pad (generally characterized by heterogeneous surface microstructure) is conditioned (resurfaced) by mechanical and/or by other means to produce a uniform and desirable surface microstructure or texture of the pads. To ensure that such conditions have been met, it is imperative to characterize and analyze CMP pads before and during the CMP process.

The prior art involving the use of ultrasound for CMP pad analysis utilizes the amplitude of ultrasound reflection from the pad surface to estimate its roughness, and time of flight between ultrasound reflections from pad surface to the groove bottom of a groove as a measure of groove depth. The prior art also shows accomplishment of CMP pad analytical objectives irrespective of how ultrasound is coupled to the pad, that is, by immersing it in water or by non-contacting it, such as in ambient air or other gases. For example, U.S. Pat. No. 6,684,704, which utilizes non-contact ultrasound, only shows the reflectance technique for pad surface measurements, and not the groove depth

### SUMMARY OF THE INVENTION

Briefly, according to this invention, there is provided a method of characterizing the surface of a CMP pad by directing an ultrasound pulse at the surface from an ultrasound transducer that is not in contact with the surface and observing the frequency spectrum of the reflected pulse.

This invention utilizes the characteristics of the frequency components of reflected ultrasound signals from a CMP pad surface for the examination performed by liquid immersion or by non-contact (air/gas coupled) ultrasound characterization. This invention is based upon characterization of frequency components reflected from the pad surface in which, in the non-contact ultrasound mode, time domain reflections from the pad surface and from the groove bottom enable the groove depth to be measured.

When ultrasound waves, particularly those emanating from a broadband transducer, hit a material of rough surface, some of its frequencies (generally higher frequencies) are scattered by the material roughness. In general, ultrasound scatter occurs when its frequency (thus, wavelength in the ultrasound carrier medium) is within the proximity of material surface roughness. Therefore, by investigating ultrasound scatter as a function of frequency (also known as frequency dependence of ultrasound attenuation) from the surface of a material, its roughness and other characteristics can be deciphered.

By analyzing a variety of components available in the frequency domain of ultrasound reflected from the CMP pad surface and the pad's other features, one can visualize their representation in formats, such as images corresponding to pad roughness, groove depth, and other features.

### BRIEF DESCRIPTION OF THE DRAWINGS

Further features and other objects and advantages will become clear to those skilled in the art from the following detailed description made with reference to the drawings in which:

FIG. 1 is a graph of the ultrasound time and frequency domain characteristics obtained for ultrasound reflections from an optically flat surface;

FIG. 2 is a graph of the frequency domain of ultrasound reflections from an unused CMP pad;

FIG. 3 is a graph of the frequency domain of ultrasound reflection from a conditioned (5 minutes with 800 grit SiC abrasive disc) CMP pad; and

FIG. 4 is a graph of the frequency domain reflection from the CMP pad with a groove.

### DESCRIPTION OF THE PREFERRED EMBODIMENTS

### Example 1

### Comparative Flat Surface

An optically flat surface of clear fused silica was observed using the water immersion ultrasound technique:

Transducer: Ultran VSP-20: Nominally, 40 MHz frequency and 20 ns pulse width with an active diameter of 3.2 mm.

Transducer excitation and amplification: 500 MHz spike pulse receiver:

Display and measurement: 2 GHz digital oscilloscope with Fast Fourier Transformation capability.

Ultrasonic technique: Water immersion pulse-echo:

Linear distance from transducer to material surface: 4.0 mm.

Waveform monitored: Ultrasound reflection from the surface of the test material.

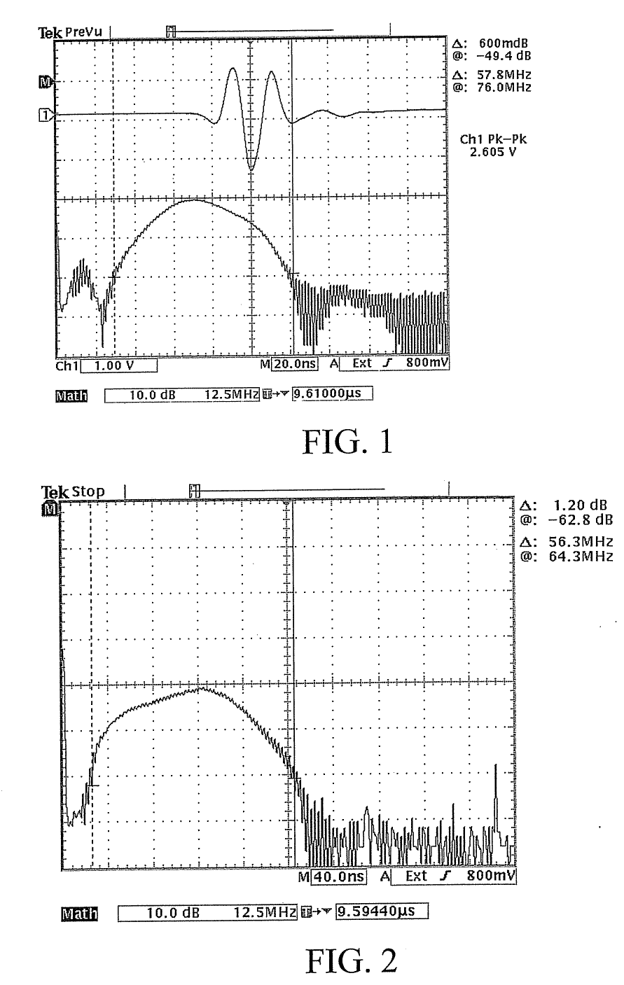

FIG. 1 is a graph (oscilloscope trace) showing the reference time and frequency domain characteristics of the transducer obtained as a function of ultrasound reflection from the optically flat surface of clear fused silica glass in deionized water.

The top trace is the time domain envelope exhibiting the shape and size of the ultrasonic pulse, which is approximately 20 ns as measured between the two peaks at the top of the waveform. Horizontal scale: 20 ns/d. Vertical scale: 1.0 V/d.

The bottom trace displays the frequency components of the top trace exhibiting the frequency domain characteristics of ultrasound reflection. Horizontal scale: 12.5 MHz/d. Vertical scale: 10 dB/d.

The purpose of this “optically flat” reference block is that it provides a surface that is essentially free from any measurable roughness. Therefore, the received frequency curve information (lower trace in FIG. 1) is purely representative of the transducer's characteristics.

Salient measured frequency characteristics are as follows:

Peak frequency: Approximately 44.0 MHz

Low frequency (Fl) at −20 dB: 18.3 MHz

High frequency (Fh) at −20 dB: 76.0 MHz

Bandwidth at −20 dB (Fh−Fl): 57.8 MHz

Bandwidth center frequency (bcf=Fh−Fl/2): 47.15 MHz.

### Example 2

### Unused CMP Pad

An unused CMP pad was observed using the water immersion ultrasound technique:

The CMP pad used in this experiment: RODEL CR IC1000-A3, manufactured by Rohm and Haas.

FIG. 2 is a graph of the frequency domain of reflection from an unused CMP pad.

Horizontal scale: 12.5 MHz/d. Vertical scale: 10 dB/d.

Salient measured frequency characteristics of FIG. 2 are as follows:

Peak frequency: Approximately 39.0 MHz

Low frequency (Fl) at −20 dB: 8.0 MHz

High frequency (Fh) at −20 dB: 64.3 MHz

Bandwidth at −20 dB (Fh−Fl): 56.3 MHz

Bandwidth center frequency (bcf=Fh−Fl/2): 36.15 MHz.

FIG. 2 shows the changes that happen to the frequency spectrum after the reference block has been replaced with an unused (new) CMP polishing pad. Notice that the peak frequency, low frequency (Fl) at −20 dB, high frequency (Fh) at −20 dB, bandwidth at −20 dB, and bandwidth center frequency (bcf) all changed when this switch occurred. If the frequency curves were printed onto transparency films and laid on top of each other, how the curves have changed their shape can be observed. The list of measurements above would reflect these changes.

### Example 3

### Conditioned CMP Pad

A conditioned CMP pad was observed using the water immersion ultrasound technique:

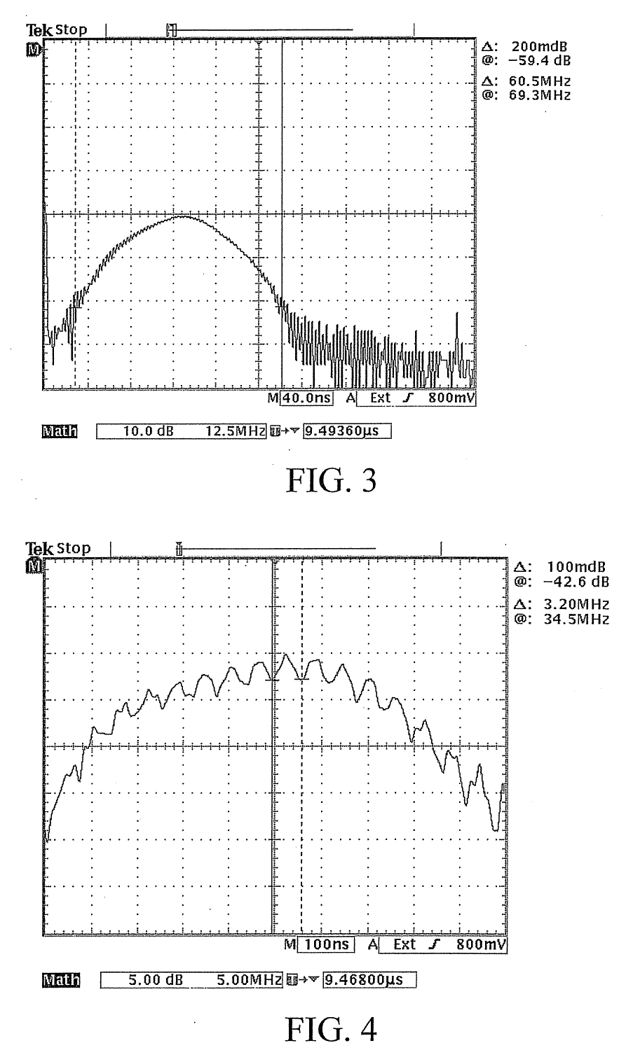

FIG. 3 is a graph of the frequency domain of reflection from a conditioned (5 minutes with 800 grit SiC abrasive disc) CMP pad. Horizontal scale: 12.5 MHz/d. Vertical scale: 10 dB/d.

Salient measured frequency characteristics of FIG. 3 are as following:

Peak frequency: Approximately 40.5 MHz

Low frequency (Fl) at −20 dB: 8.75 MHz

High frequency (Fh) at −20 dB: 69.3 MHz

Bandwidth at −20 dB (Fh−Fl): 60.5 MHz

Bandwidth center frequency (bcf=Fh−Fl/2): 39.02 MHz.

FIG. 3 shows the same information as FIG. 2, except the reflecting surface is a CMP pad after some conditioning. So although they are both CMP pads, their surface characteristics (roughness) will be different. This difference is detected by the listed changes in the frequency curve details. An algorithm based on these measurements, and/or other information which can be extracted from the frequency spectrum, can be used to correlate an actual surface roughness value.

### Example 4

### CMP Pad with Groove

A CMP pad with a groove was observed using the water immersion ultrasound technique:

FIG. 4 is a graph of the frequency domain reflection from a CMP pad with a groove. Horizontal scale: 5 MHz/d. Vertical scale: 5 dB/d.

FIG. 4 shows interference of the frequency spectrum of the pad surface with that of the groove bottom. This is identified as groove depth frequency resonance, G_{f}, which, in this case, is 3.2 MHz—note the location of two vertical cursors placed at two adjacent resonance troughs.

Groove depth is the distance between pad surface and groove bottom. Groove depth G_{d} can be determined from the following relation:

G_{d}=Vₘ/2G_{f}

where Vₘ is the velocity of ultrasound in the medium in which the pad is located (for water, the velocity of which is 1,480,000 mm/s). It is important to note that in pulse-echo techniques where ultrasound first travels from the transducer to the reflector and then back to the transducer, the measured time is actually twice that of the actual time travel. Therefore, the measured G_{f} also corresponds to twice the distance between the pad surface and groove reflection. Consequently, in the above equation a factor of 2 has been applied to determine the real groove depth, G_{d}. Since G_{f} in the present case is 3.2 MHz, thus

G_{d}=1,480,000/2×3.2×10⁶=0.231 mm.

FIG. 4 shows something different than FIGS. 1 to 3. FIG. 4 shows how groove depth information can be extracted. Although the view is zoomed in a little closer, notice that the pattern in the shape of the frequency spectrum curve. When measuring and recording the “wavelength” of this pattern with FFT, the groove depth frequency resonance (G_{f}) can be identified. This G_{f} value is then used to calculate CMP pad groove depth.

Having thus defined our invention in the detail and particularity required by the Patent Laws, what is desired protected by Letters Patent is set forth in the following claims.

The invention claimed is:

1. A method of characterizing the surface of a CMP pad by directing an ultrasound pulse at the surface from an ultrasound transducer that is not in contact with the surface and observing the frequency spectrum of the reflected pulse which is indicative of properties of the surface.

2. A method according to claim 1, further comprising measuring the amplitude of a plurality of reflected frequencies.

3. The method according to claim 1, wherein the reflected pulse is Fourier transformed enabling determination of the amplitude of a plurality of frequencies.

4. The method according to claim 1, in which the reflected pulse is observed at spaced times.

5. The method according to claim 2, in which the CMP pad has machined grooves and a groove depth frequency is identified and used to calculate the groove depth.
